(19) United States
(12) Patent Application Publication
(10) Pub. No.: US 2017/0178223 A1
(43) Pub. Date: Jun. 22, 2017

(54) SHOPPING THROUGH SOCIAL NETWORKS AND OTHER TRADITIONALLY NON-TRANSACTIONAL DIGITAL PLATFORMS AND FORMATS

(71) Applicant: ARCADIER PTE. LTD, Singapore (SG)

(72) Inventors: Dinuke Prasanna M. RANASINGHE, Singapore (SG); Paul John CASCUN, New South Wales (AU); Kenneth LOW KWOK SHION, Singapore (SG)

(21) Appl. No.: 15/312,927

(22) PCT Filed: May 23, 2014
(86) PCT No.: PCT/SG2014/000225

§ 371 Date: Nov. 21, 2016

(51) Int. Cl. G06Q 30/06; G06Q 30/02; G06Q 50/00

(52) U.S. Cl. CPC G06Q 30/0633; G06Q 50/01; G06Q 30/0277

(57) ABSTRACT

Shopping transactions through publications on social networks platforms and other traditionally non-transactional digital platforms and formats using innovative platform connected to personal virtual shopping carts, are disclosed.

### FIELD OF INVENTION

This invention relates generally to electronic commerce. More specifically, this invention relates to shopping transactions through social networks and other traditionally non-transactional digital platforms and formats, using innovative personal virtual shopping carts.

### BACKGROUND

With the development of the Internet, people are increasingly becoming more connected and informed. A number of inventions were introduced to help people efficiently exchange and share information, and connect effectively with one another through the Internet.

The internet also creates efficient ways of advertising. Internet digital advertising takes many forms today and includes but is not restricted to, banner advertising, pop-up advertising, paid and unpaid news feeds, online classifieds, and so on. Such forms of advertisements may provide product information, details of where the product may be purchased, or may even redirect the buyer to the seller's transactional web or mobile commerce site where the buyer may continue to search and eventually purchase the advertised product. This process does not instigate an immediate and direct sale between sellers and buyers, nor does this process enable the buyer to store the item for future reference.

The Internet also enables the use of digital communication platforms such as online blogs, discussion forums (for example, Blogspot, Wordpress, sgforum, hardwarezone, and so on), which are traditionally used for discussion of topical issues amongst interest groups, to become places where sellers may advertise the sale of their goods and services. Online advertisements are increasingly appearing within these forum discussion threads. Such advertisements normally describes the items being sold by the seller and will include contact information such as a telephone number or an email address which potential buyers can use to contact the sellers and complete a sale. Subsequently, payments for transactions are normally taken offline via a bank transfer or via “cash on delivery”. Similarly, other digital communication platforms such as instant messaging (egs. WhatsApp, WeChat, FB Messaging, Viber), which traditionally are used as a communication tool between two users or a group of users, are also increasingly being used by advertisers to promote items for sale, either as an exchange between two users or a group of users. In a similar manner, seller contact information is then provided to potential buyers, and payment for the transaction is then made offline.

In recent years, social networks and hybrid social networks have become increasingly popular with users worldwide, and are continuing to dramatically grow in both daily usage and the number of new users. Examples of social network platforms include, but are not restricted to, Facebook, Pinterest, Twitter, Linkedin, and Tumblr. Hybrid social network sites blend the peer-to-peer sharing capability of a social network with a specific user application, such as video or photo sharing. Examples of hybrid social networks include, but are not restricted to Instagram and Flickr. Social network platforms, digital advertising platforms, digital communication platforms (“digital platforms”) may operate within an Internet browser environment, or via a mobile application. Although access to social networks and other digital platforms occurs mostly through personal computers, increasingly, users prefer access to these platforms through their smart device(s).

This patent describes the use of an innovative system comprising a consumer-centric virtual shopping cart, enabling current communication formats used on various social network platforms and other digital platforms, which are not typically designed to enable direct purchasing, to become transactional. This increases the potential for direct sales between sellers and buyers and facilitates greater levels of electronic commerce than what is currently possible. The consumer centric virtual shopping cart that resides externally from these platforms enables the consumer to use the same shopping cart to transact across multiple merchants digital platforms simultaneously. This provides consumers an ability to store, evaluate and share items they find on digital platforms they were considering to purchase.

### SUMMARY OF THE INVENTION

The present invention enables the use of digital communication and advertising formats that currently do not have the capability to propagate commerce, to facilitate transactions primarily for the purpose of selling goods and services. Examples of these digital communication and advertising formats include but are not restricted to digital images, animation, videos, digital messages, instant messages and advertising notices. These communication and advertising formats are already currently used extensively by digital platforms such as social networks, blogs, forum sites, messaging systems, instant messaging systems, classified advertising aggregators, notice boards, websites, mobile sites, electronic marketplaces, and so on.

The present invention comprises a digital selling system (“System”) that enables an individual or organisation, who intends to promote saleable item(s) on a social network platform or on other digital platforms, to increase the capability in using such platforms for direct sales.

In particular, the present invention facilitates electronic commerce through the use of a consumer-centric virtual shopping cart (“Cart”). This Cart allows users (“Buyers”) to add and retain details of many item(s) for sale from multiple social network platforms and other digital platforms which are promoted by different merchants, to the same Cart. Buyers are able to keep such items in their Cart, even after leaving these platforms, and subsequently share the items with friends and family, and also pay for the item(s) eventually at their own convenience.

Through the combination of the innovative System and the Cart, “Sellers” are able to now sell items on various social networking platforms and other digital platforms, which may have not traditionally provided commerce capabilities.

The invention optimises the process of selling goods and services through online platforms. The System provides sellers with alternative sales channels by augmenting items for sale, represented through various communication formats, and delivered via social network platforms and other digital platforms. The augmented process provides Buyers with customised information on the item(s) for sale, and enables the item(s) to be purchased directly from the Sellers. As the System enables Sellers to feature item(s) for sale in traditionally non-transactional features of these platforms, such as newsfeeds, profile pages, and forum threads, the probability of a successful sale is increased.

This invention also improves the efficiency of digital advertising by enabling the advertiser to directly engage in the sales process with Buyers. When Buyers click on a digital advertisement, the item(s) for sale is dropped into their. Cart, which they may purchase immediately, or at a later stage. The Buyers may place items from various digital advertisement across multiple online platforms into their Cart, and these will also remain in the Cart until the Buyers decides to purchase or share items with friends and family. The Buyers are not re-directed to another electronic Commerce or mobile Commerce site to initiate a purchase, but instead, taken directly to their Cart to review the product information and/or purchase the item(s). Although cart-enabled digital advertising purchasing does exist for some social network platforms, these carts are designed only for transactions for a specific platform, and are unable to facilitate purchases from other platforms. The process defined by the present invention is preferable and more efficient for Buyers because it circumvents the need for them to sift through numerous sites or platforms in finding item(s) they spotted on advertisements and now wish to purchase. For Sellers, the System provides a more directed method of selling their goods and services.

The invention also enables transactions to directly occur on digital classifieds and other similar online sites where items are listed for sale (for example; Gumtree, Locanto, Craigslist, and so on). Sellers are able to generate transactions through notices of sale or sale advertisements, which may take the form of images and other relevant content. Buyers may select item(s) they wish to purchase through a method such as a ‘click’, which then places the item(s) into their Cart. If the Buyers wish to make purchases, they are taken to the payment stage to effect purchase of the item(s) provide any other instructions if necessary and then select delivery options. After the Sellers receive the funds from the Buyers, the Sellers may dispatch the item(s), through enabling a digital download or organise a physical pick up. Since the Cart always retains items in it, the Buyer may purchase at any time, or share details of the items with friends and family at any time as well.

In addition, the System enables Sellers who utilise social network platforms to generate transactions through uploaded images and other relevant content such as newsfeeds, profile pages, wall posts and so on. Transactions may also be generated through the paid advertising section of a social network site. Buyers may select item(s) they wish to purchase through a method such as a ‘click’, which places the item(s) into their Cart. If the Buyers wish to make purchases, they are taken to the payment stage to purchase the item(s), include any other instructions if necessary, and then select delivery options. After the Sellers receive the funds from the Buyers, the Sellers may dispatch the items, through enabling a digital download or organise a physical pick up. If Buyers wish to share information from Sellers to their network connections via a “share”, “pin”, “tag”, “repost”, “retweet”, “reblog”, “like” or similar sharing functions, this enables the Sellers' posts to be reposted to the ‘Buyers’ network connections. The Buyers' network connections may also select the items into their Cart by ‘clicking’ on the image shared by the Buyers and proceed through the transaction experience described above. Additionally the System enables the Buyer to ‘click’ an item and keep it in their Cart for future reference, Even if the Buyer leaves the digital platform from which they found the item, the item remains in their Cart for them to purchase or share at a later stage.

### DETAILED DESCRIPTION

The present invention is a digital selling system comprising of a proprietary portal and a proprietary server. This invention enables an individual or organisation to promote and facilitate sale of goods and services on social network platforms and other traditionally non-transactional digital platforms and formats through the use of a consumer-centric virtual shopping cart (“Cart”).

A person or organisation who intends to sell an item (“Seller”) first registers an account on the proprietary portal or via other interfaces with connectivity to the proprietary server. The portal may be accessed on a web browser or through an application on a computer or any smart device including but not limited to smartphones, tablets and so forth. Upon registration or through other forms of validation of identity, Sellers may load information of their items into the proprietary portal connected to the proprietary database on the proprietary server. Returning Sellers may or may not be required to log into the system again to perform a load of information into the proprietary portal. In some instances, when the proprietary database on the proprietary server is interfaced directly with an organisation's existing portal, the Seller may access the proprietary database via the organisation's existing portal. The information that can be uploaded are non-exhaustive and includes but are not limited to item names, item description, item price, images, videos, applets, delivery details, charges and so forth. These items can be uploaded individually or in a group, manually or via a file load such as via Flat Files, a CSV file, a Microsoft Excel file and so forth or via an application programming interface (“API”) into any server, which holds inventory or merchandising information. The information of the item(s) is loaded into the proprietary database on the proprietary server. The Seller may then select the social network platform(s) or other digital platforms on which he wishes to promote or sell item(s). Examples include; Facebook, Pinterest, Google+, Youtube, Viki, or Blogs or Forum sites (Twitter, Blogspot, Wordpress, Hardwarezone), Online Classifieds, Banner Advertisements, Instant Messengers (eg. WhatsApp, WeChat, FB Messaging, Viber), or Emails. Some of these platforms would be Blogs or Forums sites, Online Classifieds, WhatsApp are traditionally non-transactional platforms. Some of these formats such as banner advertisements and pop-up advertising are traditionally non-transactional as well. Upon selecting the social network platforms or other digital platforms to be used as sales channels, the proprietary server generates embedded links, frames, URLs and other forms of posting codes suited for publishing on the selected platforms. The Seller may publish the item(s) using the generated links or codes on the selected platform(s) through the proprietary portal.

Where there is no direct automated capability to publish items on social platforms or sites, the Seller may copy and paste the required URLs or codes from the proprietary portal into the respective platforms or sites.

In one aspect of the present invention, the System may be an automated system, which comprises of a set of widgets the Seller utilises to compose posts for promotion or sale and automatically publishes the post to the selected platform(s) on behalf of the Seller. The widget includes but is not limited to templates and tools which the Seller may utilise to cater to the selected platforms. Upon selection of the platform(s) on which the Seller wishes to promote or sell his goods or services, the Seller may customise the post to suit the platform(s) selected and activates the automated publish functionality. Some platforms may require the Seller to login to the selected platform(s) before a post is published. In those instances, upon logging in to the selected platform(s), the System automatically publishes the goods and services on the selected platform(s) using the generated links or codes. The widget may utilise a remember me function, which does not require the Seller to login to each platform each time the Seller wishes to publish a post through the System. This reduces the need to reconnect to these platforms again for future posts. The widget may also request for the Seller's various login credentials during the registration process, which is retained for publishing posts from the System to the platform(s). This reduces the need for the Seller to login repeatedly during the time of publication. For platforms that do not require a login, the widget will automatically publish the post on behalf of the Seller.

With reference to FIG. 1, a Seller 101 first registers and then logs in to the proprietary portal 102 and uploads information of the item he wishes to sell 103 onto the proprietary portal 102. The information would then be loaded onto the proprietary database on the proprietary server 104. Upon selection of the social network platform(s) on which the Seller 101 wishes to promote or sell his items, the proprietary server 104 then generates embedded links, frames, URLs and other forms of posting codes suitable for the selected social network platforms. The Seller 101 may then publish his items using the generated links or codes through the proprietary portal 102 onto selected social network platforms such as Social Networks 105 (e.g. Facebook, Pinterest, Google+, Youtube, Viki), Blogs 106 (e.g. Twitter, Blogspot, Wordpress), Forums 107 (e.g. SgForums, Hardware Zone), Online Classifieds 108 (e.g. Gumtree, Locanto, Craiglist), Banner Advertisements 109, Instant Messaging 110 (e.g. Wechat, Whatsapp, Viber) or on Emails 111.

In FIG. 2, a Seller 201 who intends to sell an item registers or logs into the proprietary portal 202. The Seller 201 then loads the inventory onto the proprietary portal 202 and the information is loaded onto the proprietary database 203 on the proprietary server through various methods as described in FIG. 1. Upon selection of the social network platform(s) on which the Seller 201 wishes to promote or sell his items, the proprietary server then generates embedded links, frames, URLs and other forms of posting codes suitable for the selected social network platforms. The Seller 201 may then publish his items by pasting the direct URL 205 onto the platforms and sites 208, or pasting the generated embedded links 202 or framed URL 206 in his post on social network platforms, blogs, forums, emails, banner advertisements, online classifieds and so forth 207, 209, in accordance to the way the various platforms or sites require or allow users to load images, messages or descriptions on their newsfeeds, posts, pins, updates, messages or files. The link 202 can be hyperlinked to an image, video, applet or text by the Seller. The Seller may also leave it directly as a link on the platform or site for someone to “click” on. Framed codes are used to merge the URL and images to the required short codes, short URL or special code required by the various social network platforms and sites for publication.

In FIG. 3, a Seller 301 logs in to the proprietary portal 302 and loads information of his goods and services, either manually or via an API, onto the proprietary database 303. The Seller 301 can then select which items the Seller 301 wishes to list or advertise, and utilise the widgets 304 to compose the post to be published on the social network platforms. Once the Seller logs in to the selected social network platforms 306, the System automatically publishes the items for sale on the selected social network platforms.

In one aspect of the present invention, the Seller may select the format of the post to be published. For example, the Seller may publish only the description of the item or the image and the description, or the image and QR Code/barcode, or an applet, or an image or video so forth. FIG. 4 is an example of the formats of publications.

In another aspect of the present invention, the Seller may choose to publish only a single item in a single post or multiple separate items in a single post. FIG. 5 is an example of the layout publications.

A Buyer may purchase item(s) published by Sellers using the System, regardless of whether the Buyer has registered an account on the proprietary portal. An unregistered Buyer who sees item(s) published for sale by a Seller using the System, may ‘click’ on the post. Upon this action, the item is added into a browser based Cart. Once the item is added to the Cart, details of the item including but not limited to; its description, price, availability and so forth, is shown in the Cart. For example, the item is no longer available for sale or should there be changes to the details of the item (e.g. sold out, change price, other information for example only a certain colour is left). If there are any changes to the status of the item, the System will update the Cart and have the updated details reflected as long as the Buyer has access to the Internet or other forms of data connectivity that allows the Buyer to access the proprietary database. In some instances, any changes to the details of the item (eg. sold out or number of items remaining unsold) may also be reflected on the published post, as the System is capable of reflecting real-time information on the published post itself. Buyers will see if item(s) are sold out or still available for purchase. The Seller is also able to instruct the System to remove posts from the platform(s) when item(s) are no longer available for sale. This may occur both manually or automatically, provided the platform(s) allow for such an action to occur and the Buyer has access to the Internet or other forms of data connectivity, which allows updates to reflect on the post from the prop to their network to their network to their network proprietary database. Through the Cart, the Buyer may select their preferred method of payment, which can be done through Credit Card, Debit Card, Direct Bank Account, Pre-paid store value or alternative payment methods (eg. PayPal, Google Wallet), and the method of delivery or shipping (depending on the options made available by the Seller).

If the Buyer had registered for an account on the System, the Buyer may add the item they wish to purchase from the platform(s) into a Cart application designed for specific use with the System (e.g. Mobile Application in a smart device). Once the item is added to the Cart on the application, details of the item including but not limited to its description, price, availability and so forth would be reflected and can be accessed from the Cart. If there are any changes to the status of the item, the System will update the Cart and have the updated details reflected as long as the Buyer has access to the Internet or other forms of data connectivity that allows the Buyer to access the proprietary database. If the Buyer decides to purchase the item(s), the Buyer may proceed to “check out” and complete their purchase. Through the Cart application, if the Buyer has previously added his payment credentials, the Buyer may proceed to complete the purchase using the stored details of his method of payment and without having to key them in or other relevant details such as the recipient's name, delivery address and so on. If the Buyer has not stored any of his payment credentials, the Buyer can still then enter his payment credentials manually into the System to make payments. Likewise if there are changes to the Buyer's other profile information, such as his delivery address, or other relevant details never previously entered into the System, the Buyer may still make the changes to such details at the time of effecting the transaction. The Buyer may also choose to enter alternative payment method credentials (for example; via PayPal, Google Wallet) at the time of the transaction, if these credentials were not previously stored in the System.

Alternatively, a registered Buyer can choose to use a browser based Cart instead of the Cart application. Upon ‘clicking’ the post, the item(s) are added into a browser based Cart. Once the item(s) are added to the Cart, details of the item(s) are including but not limited to description, price, availability and so on, would be reflected and can be accessed from the Cart. The Buyer may then log in to their account and thereby proceed to ‘check-out’ and complete the purchase using the stored details of their method of payment and without having to re-key them, or other relevant details such as the recipient's name, delivery address and so on. If the Buyer has not stored any of his payment credentials, the Buyer can still enter his payment credentials manually into the System to make payments. Likewise if there are changes to other profile information such as delivery address, or other relevant details never previously entered into the System, the Buyer may still make the changes at the time of the transaction. The Buyer may also choose to enter alternative payment method credentials (for example; PayPal, Google Wallet) at the time of the transaction, if these credentials were not previously stored in the System.

In one aspect of the present invention, the Seller may log in to his account on the proprietary portal to see if any item(s) they are selling was added into any Carts. With this knowledge, the Seller may interact with the Buyer to expedite a sale.

Once payment is approved, the purchase is complete. The Seller is notified of the sale via the proprietary portal and other means made available by the System and selected by the Seller (e.g. In-app notification, Email etc.), after which the Seller may proceed to fulfil the order of the Buyer.

FIG. 14 depicts the unregistered Buyer's flow where the Buyer 1401 sees items he wishes to purchase on social networks or blogs or forums etc. 1402 and clicks on the “advertisement” 1403. Upon clicking of the advertisement, the item is then added to a browser based Cart 1404. Once the item is added to the Cart, details of the item including but not limited to its description, price, availability and so on, are reflected and can be viewed from the Cart. If there are any changes to the status of the item, the System will update the Cart and have the updated details reflected as long as the Buyer 1401 has access to the Internet or other forms of data connectivity that allows the Buyer 1401 to access the proprietary database 1405.

The Seller may also log in to his account on the proprietary portal and check if the item has been added into any virtual carts and interact with the Buyer or make an offer to the Buyer 1406.

If the Buyer 1401 decides to purchase the item, the Buyer 1401 may proceed to ‘check out’ and enter the required details 1407. Upon checking out, the Buyer 1401 may make payment for the item using Credit Card, Debit Card, Direct Bank Account, Pre-paid store value or alternative payment methods (for example; PayPal, Google Wallet) 1408. Once payment is approved 1409, the purchase is complete. The Seller is notified of the sale via the proprietary portal and other means made available by the System and selected by the Seller (e.g. In-app notification, Email etc.) 1410, after which the Seller may proceed to fulfil the order of the Buyer 1411.

FIG. 15 depicts a flow chart of one embodiment of the process, by a registered Buyer. It also depicts how the Buyer may access his stored payment information, to facilitate the Buyer's purchase experience. In this instance, the Buyer 1501 sees item(s) they wish to purchase on social networks or blogs or forums etc. 1502, and ‘clicks’ on the advertisement 1503. Upon clicking of the advertisement, the item is then added to a browser based Cart 1504 or Cart application 1505.

If the Buyer 1501 is using a Cart application, the Buyer 1501 may add the item into the Cart application. At this stage or earlier, the Buyer 1501 can log in using the Buyer's User identification which may include but not limited to User ID, Password, Open ID, PINs. The Cart identifies the Buyer and is able to produce the Buyer's payment information, stored information (e.g. Delivery Address) and past transaction history. Once the item is added, the Buyer 1501 can check the details of the item being offered, including other details of delivery or shipping (1507). If the Buyer 1501 decides to purchase the item, the Buyer 1501 may complete the purchase using the stored details of his method of payment and without having to re-key them in or other relevant details such as the recipient's name, delivery address and so on 1506.

If the Buyer 1501 is using a browser based Cart, once the item is added to the Cart, details of the item including but not limited to its description, price, availability and so forth would be reflected and can be accessed from the Cart. If the Buyer 1501 decides to purchase the item, the Buyer 1501 may proceed to check-out. The System would then update the tart with changes to the status of the item, if any and launch the payment flow 1507. The Buyer 1501 may then log in to their account on the browser based Cart and complete the purchase using the stored details of his method of payment and without having to key them in or other relevant details such as the recipient, delivery address and so forth 1508. The Buyer 1501 may also enter further details and proceed to ‘check-out’ 1509.

Upon checking out, the Buyer 1501 may make payment for the item using Direct Bank Account, Pre-paid store value, Credit Card, Debit Card or alternative payment methods (for example; PayPal, Google Wallet) 1510. Once payment is approved 1511, the purchase is complete. The Seller is notified via the proprietary portal and other means made available by the System and selected by the Seller (e.g. In app notification, Email etc.) 1512, after which the Seller may proceed to fulfil the order of the Buyer 1513.

In another aspect of the present invention, items from various platforms and sites as well as from different sellers can be added into the same Cart. In this instance, regardless of whether the Buyer is a registered user or continues to use the system as a Guest, the Buyer will be able to add items into the same Cart. The items will remain in the same Cart for as long as the Buyer does not proceed to payment and if the items are not deleted. Items from multiple platforms and merchants can reside in the same Cart as long as the Cart identifies the buyer to be the same individual (e.g. through use of login identities or PINs to identify the same individual).

FIG. 16 depicts how items from various platforms and sites, as well as from different sellers, can be added into the same Cart. In this instance, the Buyer may chance upon Item 1 from Seller A on a social network 1601, Item 2 from Seller B on a blog 1602, Item 3 from Seller C on a forum 1603 and Item 4 from Seller D on an email 1604. The Buyer may then add all the Items 1, 2, 3 and 4 into the same Cart 1605. The Buyer is able to access the Cart as an application on smart devices 1606 or a browser based Cart on any computers, smart devices, or any other means with Internet access and any other data transmission that connects to the proprietary database 1608.

### BRIEF DESCRIPTION OF THE DRAWINGS

FIG. 1 provides the overall diagrammatical flow which depicts how a seller publishes items or offers through a proprietary system, and publishes them on various websites and platforms for sale.

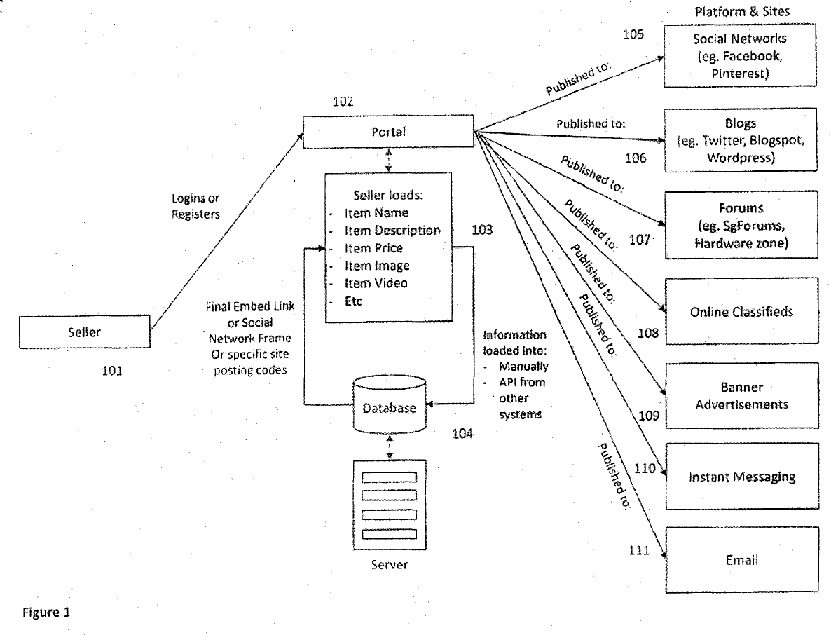

FIG. 2 provides the overall diagrammatical flow of how a seller publishes the items through a proprietary system which creates either a HTML Embedded. Tag to an item description with a separate image/video/applet load, through a Framed Image/video/applet URL or even manually directly through a URL.

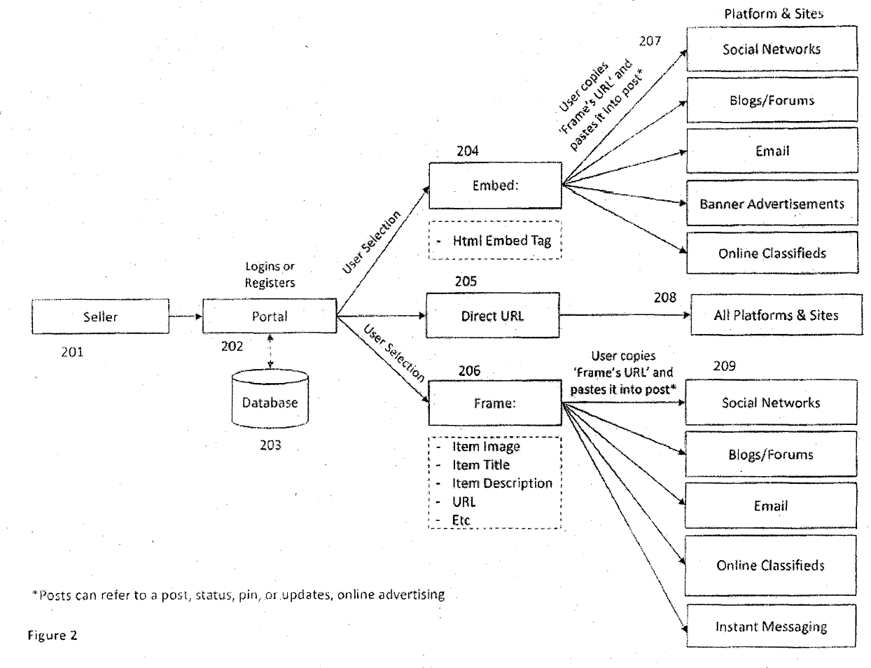

FIG. 3 provides an overall diagrammatical flow of how a seller publishes items through a proprietary system which provides widgets to enable automated post of items and offers to publish directly to various platforms and sites (e.g. Social media etc.), either on their paid ads or on free news feeds.

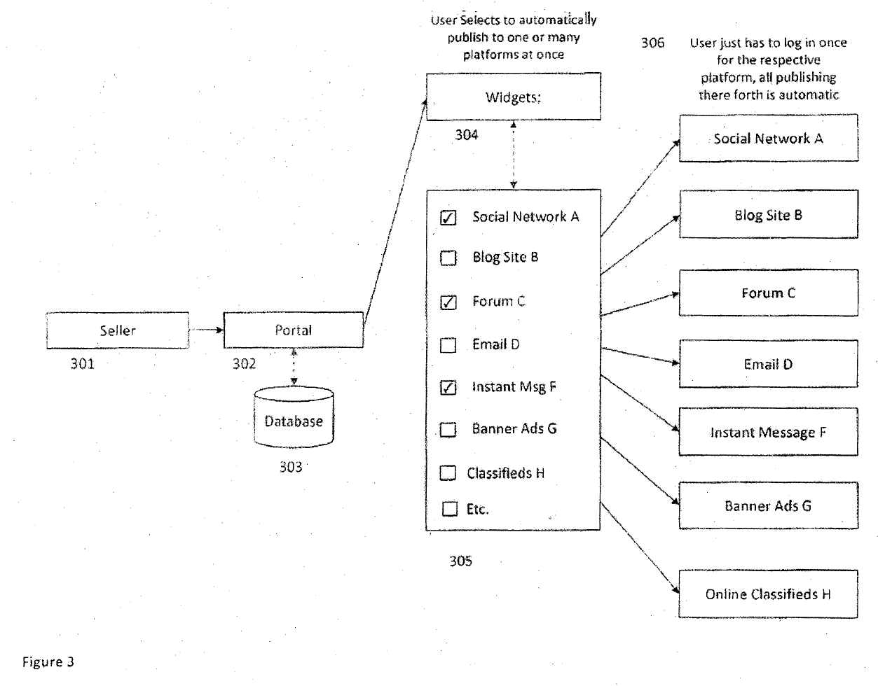

FIG. 4 is an embodiment of the invention which shows examples of the various formats which the publication of the offer for sale can take on platforms and sites. It can be a simple presentation of an item name and description; or a video, image applet or graphical representation such as a bar code. Some or any part of the published advertisement can be “clicked” on to activate the Cart. The offer can also take the form of an offer of a coupon, voucher, sale of points or any other forms of value which can be exchanged.

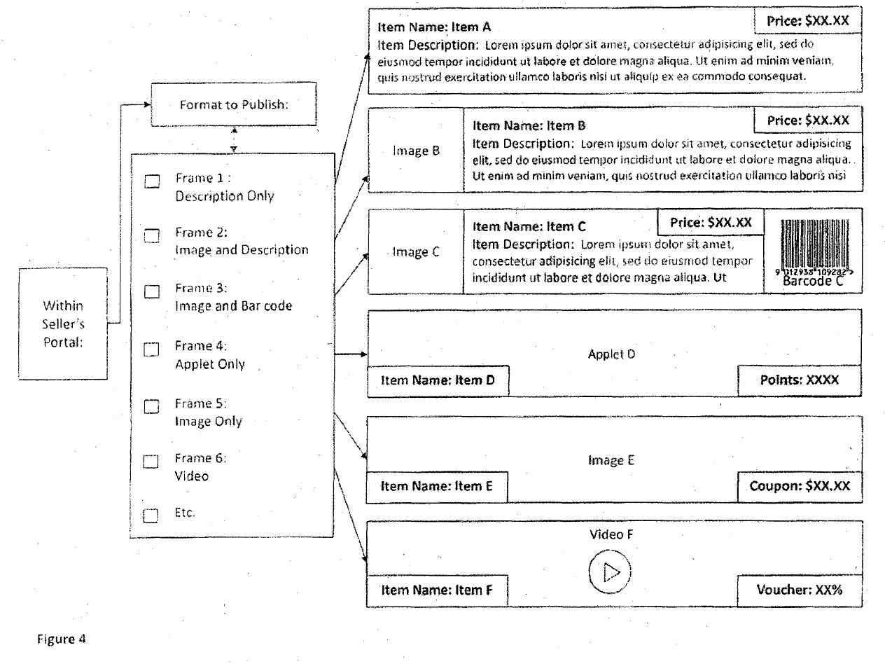

FIG. 5 is a representation of an embodiment of the invention which shows two examples of how the items for sale may be presented. There can be a single item being published for sale 501, or multiple items for sale 502. Both require a single ‘click’ to publish the item(s) for sale.

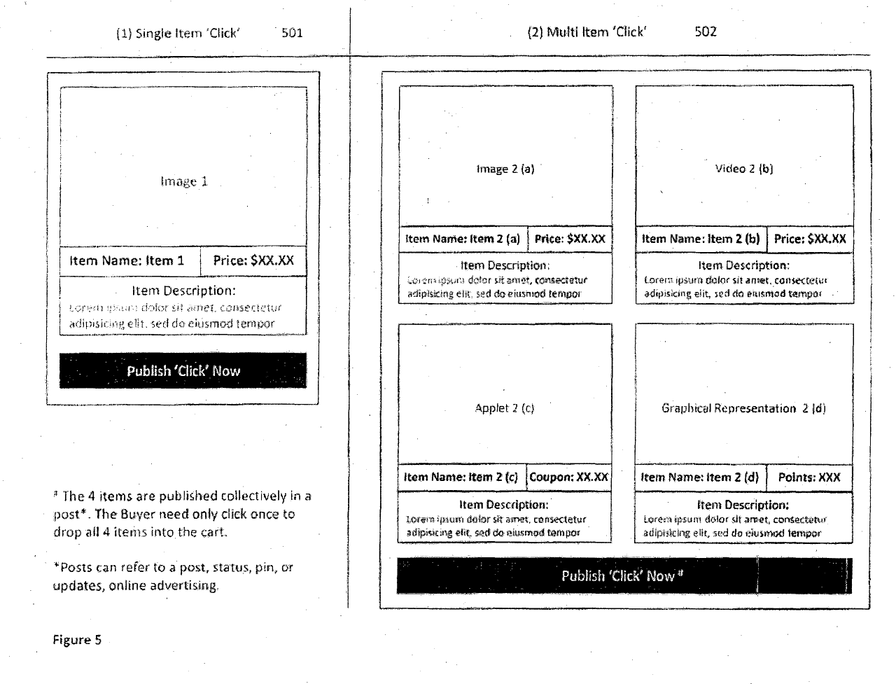

FIG. 6 is a representation of an embodiment of the invention which shows an example of how an item can be published for sale on a social network, where it is part of a paid (sponsored) advertisement. This advertisement can either be featured within the user's feed, or as a side banner ad on social platforms. By clicking on the sponsor's advertisement, the items will be added to the Cart. This invention has enabled non transactional paid advertisements to become transactional. Presentation of this embodiment can take on various forms, depending on the proprietary format of the social network platform.

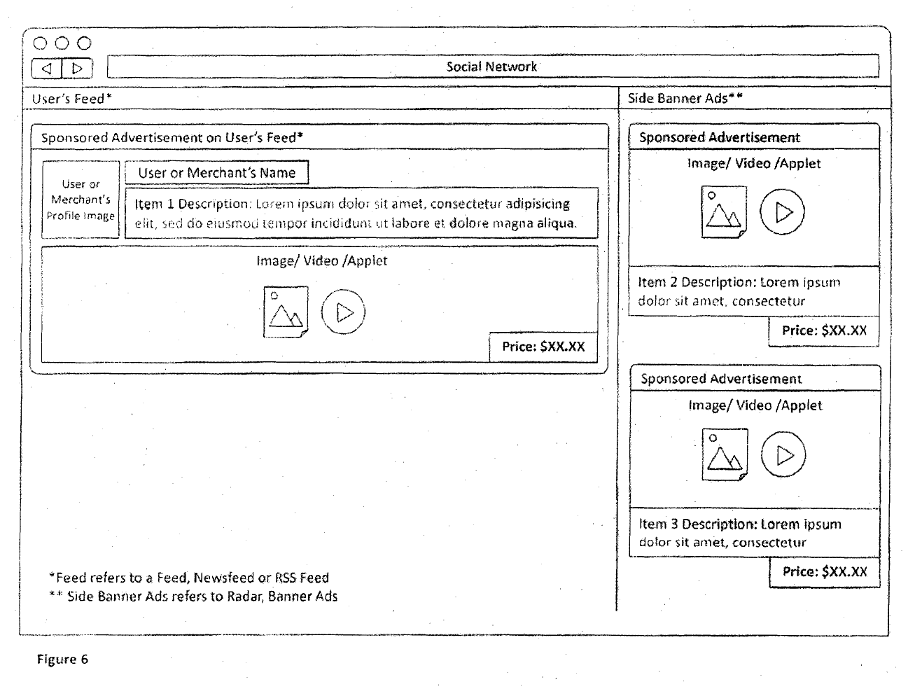

FIG. 7 is a representation of an embodiment of the invention which shows how an item can be published for sale on any social network platform or app, where the advertisement is part of an individual's post on the wall of a social site or a group wall post on a fan page, interest group page. The post is made using regular wall posting functions which are made available by the social network which users utilise to post their pictures, status, updates, tags or pins. “Clicking” on the post allows items to be added into the Cart. This embodiment may or may not require any widgets to create the post and relies on pre-existing posting capabilities made available to users who currently use the function to post their updates, pictures, videos, pins and updates. This invention allows Sellers to use non transactional portions of a social network (which are normally used for updates and sharing of static information) to become transactional without requiring any permissions from the social network platform. Depending on the layout of the individual platform walls, the “clickable” portions may include the image/video only, the item or the entire frame. Presentation of this embodiment can take on various forms depending on the proprietary format of the social network platform.

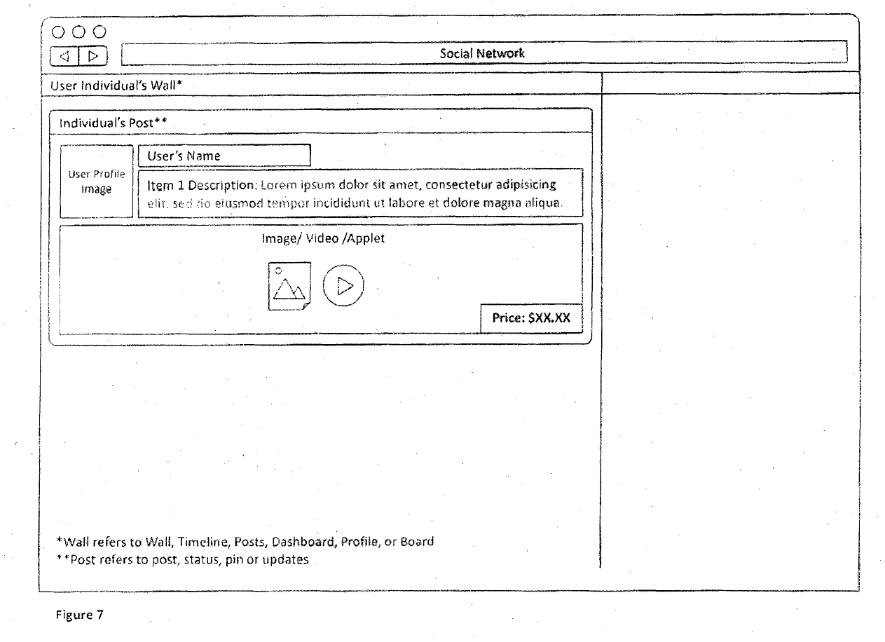

FIG. 8 is a representation of an embodiment of the invention which shows how an item can be published for sale on any social network or site, where multiple individual posts co-exist on the same page. Different users may post, pin, tag, share or provide updates and status to a single wall using the social networks free or paid tools to post, pin, tag, share or update. The post may be a social post (free post) or a paid post (sponsored post and advertisement). Each post can be from the same seller or different sellers. Buyers are able to click on each post and the items will be added into the Cart. For example, a buyer can click on items 1, 3 and 5 and only these will be dropped into the Cart. The rest of the wall may consist of non-sale content based items, which are posted using the free tools of the platform. All parts of each post may be clickable. Presentation of this embodiment can take various forms depending on the particular format of the social network platform.

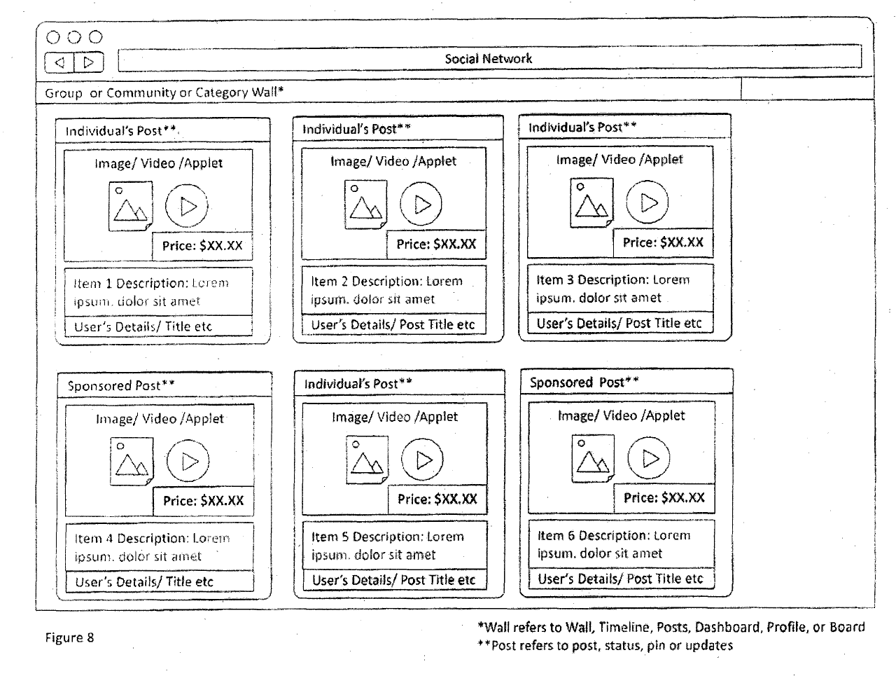

FIG. 9 is a representation of an embodiment of the invention showing how an item can be published for sale on an online forum. In this instance, the user can embed the items) for sale on to an image/video/applet, or written content. If a buyer ‘clicks’ on the image/video/applet, or written content, the item will be added into the Cart. This invention enables sellers to sell items on non-transactional forum sites, in areas traditionally used for free messaging and communication between individuals or in the paid advertisement sections. Presentation of this embodiment can take on various forms depending on the particular format of the forum platform.

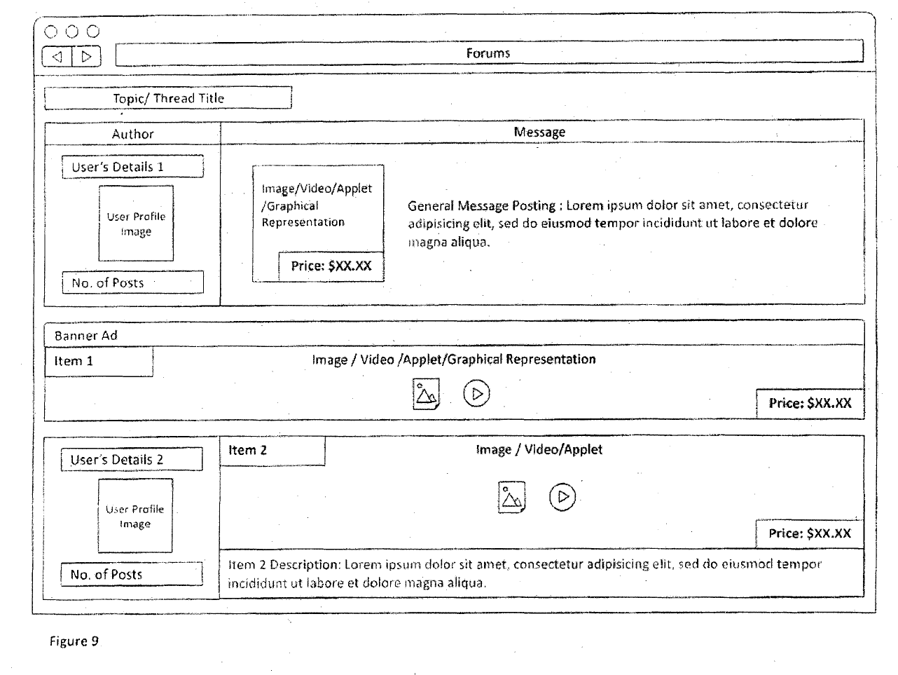

FIG. 10 is a representation of an embodiment of the invention which shows how an item can be published for sale on online blogs. In this instance, a user embeds an image/video/applet into their blog entry. Any buyer who clicks on the entry will be able to add items into the buyer's Cart. This enables the user to sell items on a non-transactional blog site. Likewise, the invention's capability also resides in sponsored advertisements if they are featured on the blog. Presentation of this embodiment can take various forms depending on the particular format of the forum platform.

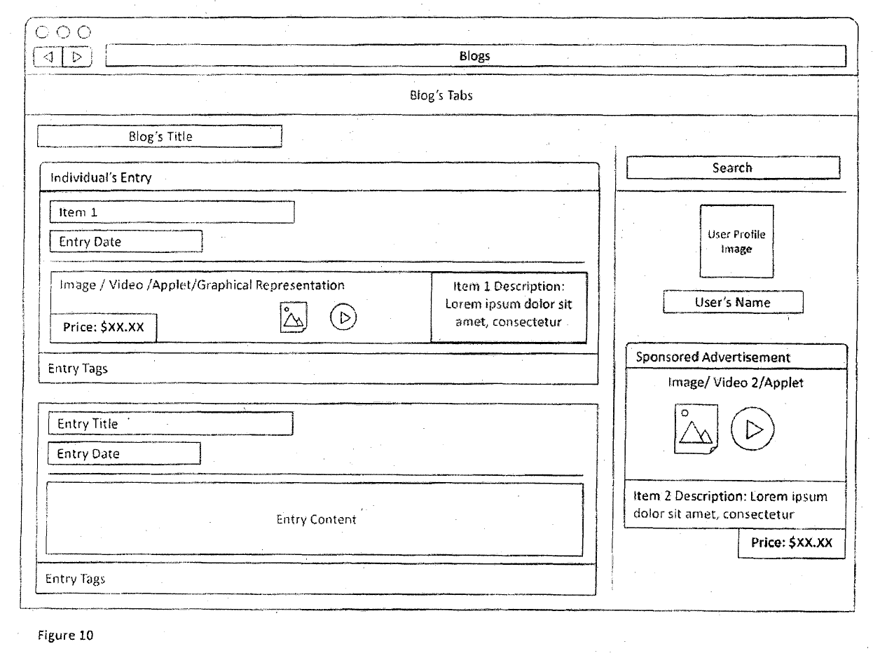

FIG. 11 is a representation of an embodiment of the invention which shows how an item can be published for sale on any banner advertisement. In this instance, a seller can embed the item for sale in any banner advertisement on a page. Regardless of the banner ad being in the top bar (banner advertisement 1), side bar (banner advertisement 2) or bottom bar (banner advertisement 3), the buyer is simply required to click on the banner advertisement and the items can be added into the Cart. Presentation of this embodiment can take on various forms depending on the particular format of the website.

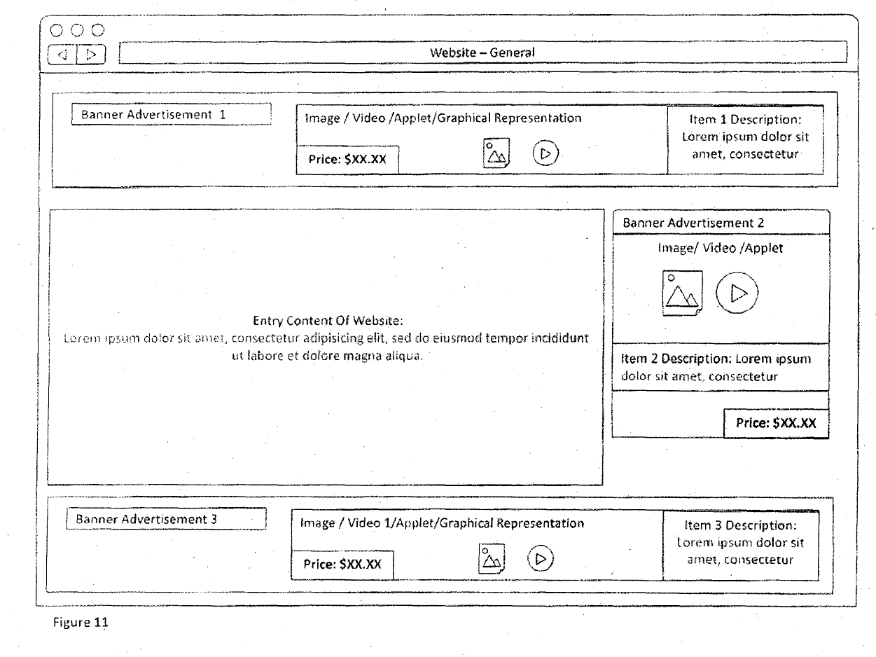

FIG. 12 is a representation of an embodiment of the invention which shows how an item can be published for sale on an online classified site. In this instance, the seller can embed the item for sale or share a link on the online classifieds page, in which a ‘click’ will direct the potential buyer to the Cart. The “clickable” part of the advertising can be the image if the URL is embedded in the picture, or it can be an outright URL link shared in the item description. Presentation of this embodiment can take on various forms depending on the proprietary format of the online classified site.

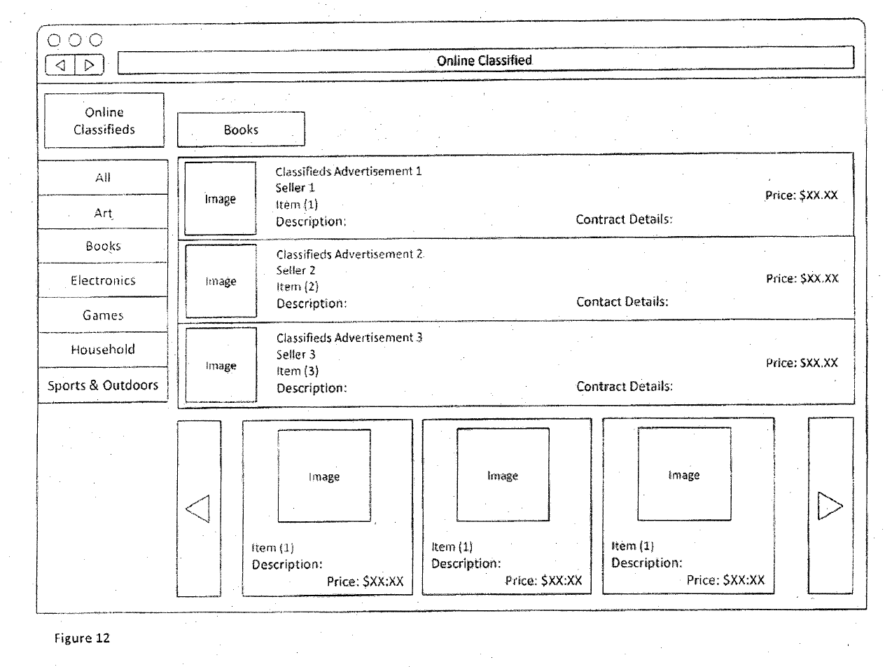

FIG. 13 is a representation of an embodiment of the invention which shows how an item can be purchased via the use of instant messaging. In 1301, when a request for sale is initiated by the buyer, Seller A views the request from the buyer and immediately types in a URL hyperlink. When the buyer “clicks” on the URL hyperlink, the Buyer will be led to a Cart with the item having already been added into the Cart for purchase. In 1302, the sale request is initiated by Seller A to the recipient. In this example, Seller A embeds a special code, short code/URL or an embed.ly to the instant message. Buyer B is able to “click” on this to launch the Cart, and the item will be available for purchase. 1303 shows a group messaging format where more than one person is in the instant messaging group. This is also possible in 1301 and 1302, where exchanges can be in the form of group messages. The example shown in 1303 is that a video or image can be embedded into the instant message. Once the potential buyer “clicks” on the video or image, it will take the Buyer to the Cart where the items would already have been included for purchase.

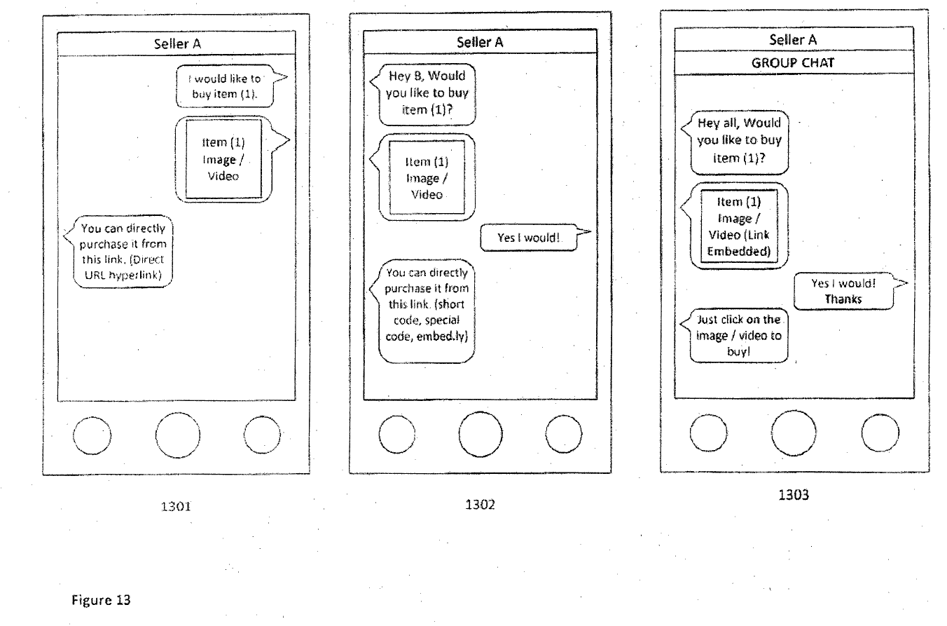

FIG. 14 provides the overall diagrammatical flow of how a Buyer utilises the invention to add items into a Cart for purchase. The Buyer is not required to register for an account or sign in to use the Cart to make a purchase.

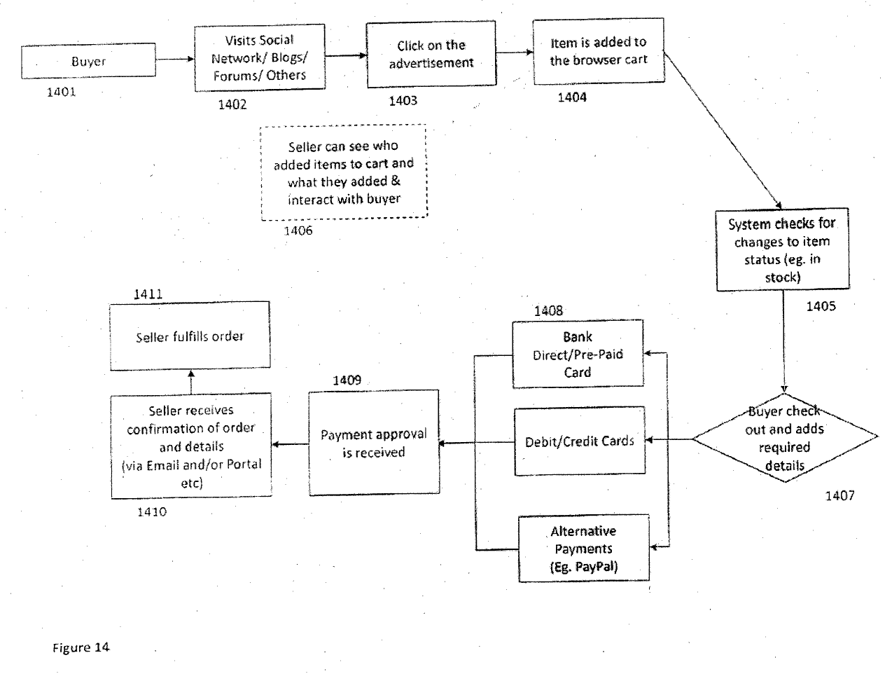

FIG. 15 provides the overall diagrammatical flow of how a Buyer utilises the present invention to add items into the Cart for purchase. The Buyer in this case is a registered user, and is able to retrieve his past history and stored payment details to facilitate the purchase of items.

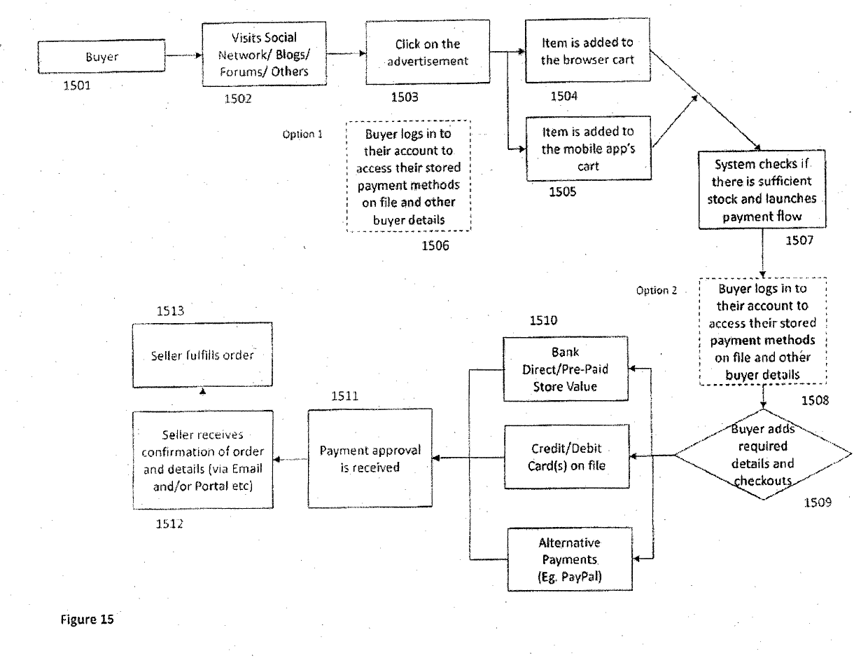

FIG. 16 provides the overall diagrammatical flow of how a buyer utilises the present invention to add items into the Cart from various platforms or sites (e.g. Social Networks, Blogs, Forums, and Email etc.). Items from the various platforms or sites are kept in the Cart for as long as the user of the Cart does not check out any items or delete them. The Buyer can access the Cart from any device in-app or in browser, as long as the proprietary server is able to identify the Buyer's identity.

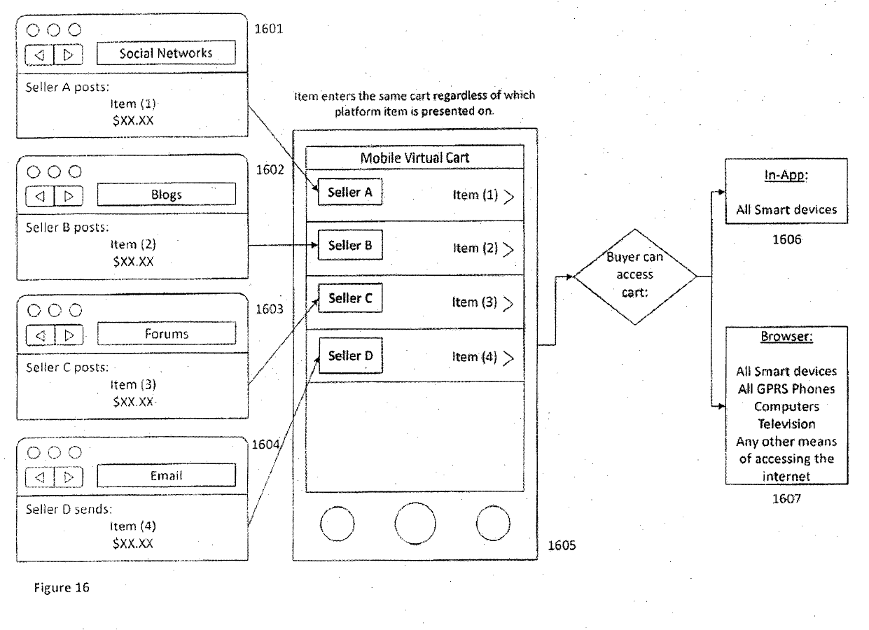

FIG. 17 is a representation of an embodiment of the invention which shows an overlay being applied to the image, video or applet showing, in real time information such as, the quantity available for sale, real time price of the item (if the Seller chooses to make the price of the item variable in the System) or any other variable information provided by the Sellers.

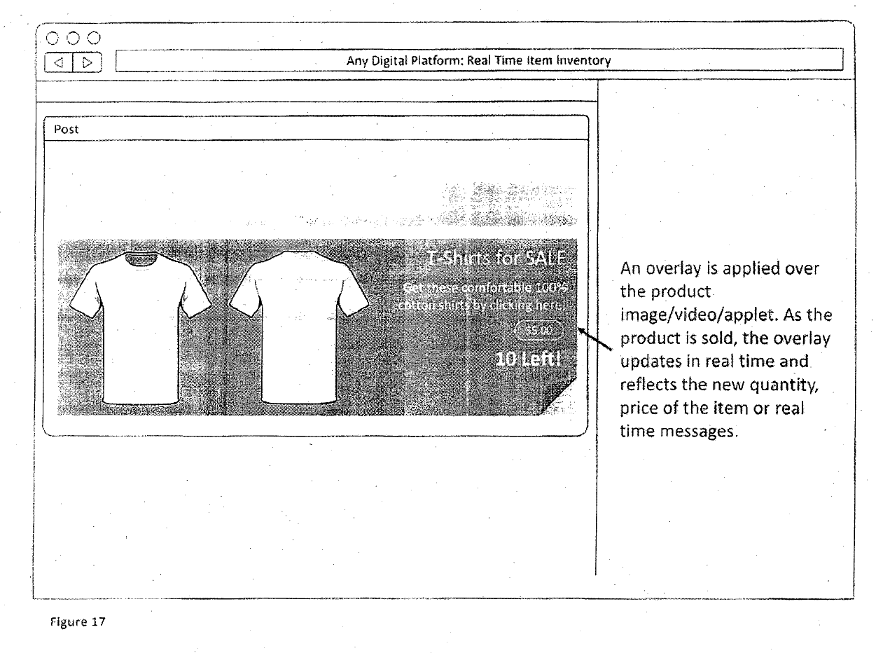

FIG. 18 is a representation of an embodiment of the invention which shows how the overlay is able to reflect that an item is not in stock or no longer available for sale, and the System will then not allow Buyers to add the particular item into their Cart.

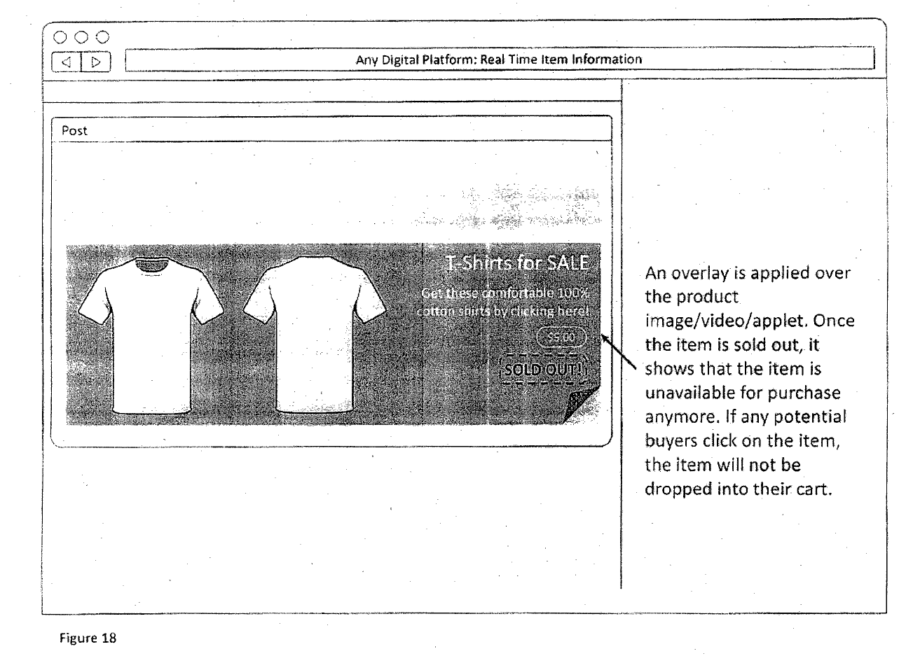

1. A new and innovative system for electronic commerce, comprising:
computer readable storage platform having computer readable programme code embodied;
computer readable programme code configured to establish portal through which a plurality of virtual shopping carts may be connected to a server via a network;
a server supporting the platform;
devices connected to the platform via the network;
a plurality of virtual shopping carts associated to devices used by merchants and consumers for commercial transactions;
the said network connecting the virtual shopping carts to the platform;
uploading of information and publication of a single item or multiple items for sale to the Internet, via a plurality of social network platforms and any other traditionally non-transactional digital platform or formats.

2. The system of claim 1, wherein the portal may be accessed through a mobile application or a web based browser on any computer or on any smart device which can operate interactively and autonomously, and which may connect to and interface with the platform via a network.

3. The system of claim 2, wherein the portal is programmed with capabilities enabling users to upload information of their products for sale, including but not limited to description, price, stock level and so forth as well as images, video or applet, into the database on the server and embed these information into the publications.

4. The system of claim 3, wherein the portal comprises of widgets enabling sellers to create and customise publications of their choice.

5. The system of claim 4, wherein the system can retain the user's social network account details and other digital platform credentials such that the user no longer needs to subsequently login, and the item(s) can be automatically published.

6. The system of claim 5, wherein publications of items for sale may be automatically published on selected social network platforms or other digital platforms by the proprietary portal simply upon the user logging in to the user's account on the selected platforms.

7. The system of claim 5, wherein the item(s) in the system can be automatically published if the system is able to identify the application is resident in the smart device of the user, such as instant messaging application or other application without a need for the user to login an identity.

8. The system of claim 7, wherein items published using links or codes generated by the proprietary portal or automatically published via the proprietary portal would be added into virtual shopping carts upon clicking of the publication.

9. The system of claim 8, wherein upon a user tags, shares, re-post, re-pins, re-tweet, re-tags, re-blogs or forwards the seller's post, pin, message, other users of the social network platforms or other digital platform will similarly be able to view and purchase from the shared sale publication.

10. The system of claim 9, wherein items from multiple unrelated sellers on separate sources can be entered into the same virtual shopping cart.

11. The system of claim 10, wherein the system is able to withdraw or delete a publication on a social network platform or other digital platform if the seller has provided such instruction to the system, automatically via pre-set instructions or manually by access the system and sending the instructions.

12. The system of claim 11, wherein upon entry of the items into a virtual shopping cart, buyers would be able to view the information of the items in the virtual shopping cart as made available by the seller as well as the updated information of the items, as long as the device on which the virtual shopping cart is used is connected to the internet or other form of data connectivity that allows access to the proprietary database.

13. The system of claim 12, wherein the buyer can view updated information of the items on the publication real-time as long as the device on which the social network platform or other digital platforms being used is connected to the internet or other forms of data connectivity that allows access to the proprietary database.

14. The system of claim 13, wherein the entry of items into a virtual shopping cart constitutes an order of the item wherein the buyer may proceed to complete the purchase via the virtual shopping cart.

15. The system of claim 14, wherein upon entry of items into virtual shopping carts, the sellers of the items entered may be notified and the sellers would be able to log in, to their account on the proprietary portal and view the orders of their items and interact with the buyers.

16. The system of claim 15, wherein a registered buyer may proceed to complete the purchase of the items in the virtual shopping cart by making payment using the stored details and information and thereby notifying the seller to fulfil the purchase upon approval of payment.

17. The system of claim 16, wherein users which have no registered accounts with on the proprietary portal may still respond to publications and purchase items published using the proprietary portal.

18. A computer-implemented method for publishing items for sale on social network platforms, comprising:
the use of a portal through which a plurality of virtual shopping carts may be connected to a server via a network;
the use of devices connected to a platform via the network;
the use of a plurality of virtual shopping carts associated to devices used by merchants and consumers for commercial transactions;
uploading of information and publication of a single item or multiple items for sale to the internet, via a plurality of social network platforms and any other traditionally non-transactional digital platform or format.

19. The method of claim 18, wherein the portal may be accessed through a mobile application or a web based browser on any computer or on any smart device which can operate interactively and autonomously, and which may connect to and interface with the platform via a network.

20. The method of claim 19, wherein the portal is programmed with capabilities enabling users to upload information of their products for sale including but not limited to description, price, stock level and so forth as well as images, video or applet, into the database on the server and embed these information into publications.

21. The method of claim 20, wherein the portal comprises of widgets enabling sellers to create and customise publications of their choice.

22. The method of claim 21, wherein the system can retain the user's social network account details and other digital platform credentials such that the user is no longer required to subsequently login to social platform(s), and item(s) can be automatically published.

23. The method of claim 22, wherein publications of items for sale may be automatically published on selected social network platforms or other digital platforms by the proprietary portal simply upon the user logging in to the user's account on the selected platforms.

24. The method of claim 23, wherein the item(s) in the system can be automatically published if the system is able to identify the application is resident in the smart device of the user, such as instant messaging application or other application without a need for the user to login an identity.

25. The method of claim 24, wherein items published using links or codes generated by the proprietary portal or automatically published via the proprietary portal would be added into virtual shopping carts upon clicking of the publication.

26. The method of claim 25, wherein upon a user tags, shares, re-post, re-pins, re-tweet, re-tags, re-blogs or forwards the seller's post, pin, message, other users of the social network platforms or other digital platform will similarly be able to view and purchase from the shared sale publication.

27. The method of claim 26, wherein items from multiple unrelated sellers on separate sources can be entered into the same virtual shopping cart.

28. The method of claim 27, wherein the system is able to withdraw or delete a publication on a social network platform or other digital platform if the seller has provided such instruction to the system, automatically via pre-set instructions or manually by access the system and sending the instructions.

29. The method of claim 28, wherein upon entry of the items into a virtual shopping cart, buyers would be able to view the information of the items in the virtual shopping cart as made available by the seller as well as the updated information of the items, as long as the device on which the virtual shopping cart is used is connected to the internet or other form of data connectivity that allows access to the proprietary database.

30. The method of claim 29, wherein the buyer can view updated information of the items on the publication real-time as long as the device on which the social network platform or other digital platforms being used is connected to the internet or other forms of data connectivity that allows access to the proprietary database.

31. The method of claim 30, wherein the entry of items into a virtual shopping cart constitutes an order of the item wherein the buyer may proceed to complete the purchase via the virtual shopping cart.

32. The method of claim 31, wherein upon entry of items into virtual shopping carts, the sellers of the items entered into the virtual shopping cart may be notified and the sellers would be able to log in to their account on the proprietary portal and view the orders of their items and interact with the buyers.

33. The method of claim 32, wherein a registered buyer may proceed to complete the purchase of the items in the virtual shopping cart by making payment using the stored details and information and thereby notifying the seller to fulfil the purchase upon approval of payment.

34. The method of claim 33, wherein users which have no registered accounts with on the proprietary portal may still respond to publications and purchase items published using the proprietary portal.
